(19) United States
(12) Patent Application Publication
(10) Pub. No.: US 2004/0205217 A1
(43) Pub. Date: Oct. 14, 2004

(54) Method of running a media application and a media system with job control

(76) Inventors: Maria Gabrani, Gattikon (CH); Christian Hentschel, Eindhoven (NL); Cornelis Conradus Adrianus Maria Van Zon, Cold Spring (NL); Elisabeth Francisca Maria Steffens, Eindhoven (NL); Reinder Jaap Bril, Eindhoven (NL)

Correspondence Address: Philips Electronics North America Corporation, Corporate Patent Counsel, PO Box 3001, Briarcliff Manor, NY, 10510, US

(21) Appl. No.: 10/483,152

(22) PCT Filed: Jul. 12, 2002
(86) PCT No.: PCT/IB02/02748

(30) Foreign Application Priority Data
Jul. 13, 2001 (EP) 01117107.1

(51) Int. Cl. G06F 15/16; H04L 12/28; H04L 12/56

(52) U.S. Cl. 709/231; 370/395.21; 370/395.5

(57) ABSTRACT

For a flexible consumer multimedia device that remains as robust and cost-effective as the current ones, media algorithms should become more flexible with respect to their resource requirements with the exchange in output quality. We call such algorithms scalable. The state of a cluster of scalable video algorithms (Job) in a consumer multimedia terminal can be described by three parameters. The first one is the job mode, that is the actual cluster of functions and their connections. The second one is the set of valid quality levels of the job mode, which is called operational set. The last one is the assigned quality level. The first two parameters supply the correct processing and the valid search space for the system optimization, and are selected by the job itself. The latter one reflects the actual resource allocation according to the available system resources and is selected by the QoS Resource Manager.

The present invention relates to a method of running a media application, the media application comprising a number of algorithms, each algorithm being either scalable or non-scalable. The invention also relates to a media system and more particularly to a multimedia communication device.

### PRIOR ART

Consumer terminals (CTs) are gradually evolving from straightforward terminals of a video broadcast network (TV sets) and a communication network (telephone) to interactive multimedia terminals, and beyond that, to elements in an in-home network, or even an ambient intelligence environment.

In high volume electronics (HVE) CTs, such as digital TV sets and set-top boxes (STBs), multimedia Quality of Service (QoS) is used to optimize output quality. Basic media in CTs are high-quality audio and video. If the basic media processing functions are scalable, other media processing functions can be added at little or no extra cost. Scaling audio is less important than scaling video, for two reasons: combined with lower quality audio (e.g. mono), video is perceived at lower quality, and high-quality audio (e.g. multi-channel) consumes just a fraction of the resources compared to high-quality video. The challenge of multimedia QoS for CTs is in finding a QoS approach that can primarily be applied to high-quality video, and also supports other media, such as 3D graphics. High-quality video processing in CTs has a number of distinctive characteristics when compared to mainstream multimedia processing in, for example, a (networked) workstation environment, see K. Nahrstedt, H. Chu, S. Narayan, QoS-aware Resource Management for Distributed Multimedia Applications, Journal on High-Speed Networking, Special Issue on Multimedia Networking, IOS Press, Vol. 8, No. 3-4, pp. 227-255, 1998.

The QoS parameters for different types of media processing are shown to be very application domain specific. Moreover, high-quality video has very stringent timing requirements compared to other media processing functions.

The mesh, texture, and screen resolution are used as QoS parameters for 3D computational graceful degradation in G. Lafruit, L. Nachtergale, K. Denolf, and J. Bormans, 3D Computational Graceful Degradation, Proc. IEEE International Symposium on Circuits and Systems (ISCAS), Vol. 3, pp. 547-550, May 2000, while maintaining a fixed frame rate. Frequently used QoS parameters for video applications in a workstation environment are screen resolution, frame rate, image size, colour depth, bit rate and compression quality, see B. Li and K. Nahrstedt, Dynamic Reconfiguration for Complex Multimedia Applications, Proc. International Conference on Multimedia Computing and Systems (ICMCS), Vol. 1, pp. 165-170, June 1999. Spatial (resolution) and temporal (bit rate and frame rate) scalabilities are exploited in great detail in the field of image compression (MPEG*, H.26*; see for example, J. R. Morros, and F. Marqués, A proposal for dependent optimization in scalable region-based coding systems, Proc. IEEE International Conference on Image Processing (ICIP), Vol. 4, pp. 295-299, October 1999).

In Consumer Media Terminals (CMTs) with high-quality video requirements, these parameters are not generally applicable. High-quality video has a fixed field/frame-rate, no tolerance for jitter (i.e. frame-rate fluctuations), and low tolerance for frame skips, i.e. very stringent timing requirements. Moreover, the resolution of a TV screen is fit to its standard (e.g. PAL, NTSC, ATSC, VGA), and the image (or window) size is either fixed (e.g. main window or PiP window) or determined by the user. Finally, receivers in a broadcast environment, and that is what CMTs currently are, do not have the option to negotiate compression quality and bit-rate, although that may change in the future for CMTs in an in-home digital network.

Although the setting of many parameters are imposed by the environment rather than adaptable by the system for optimisation purposes, they do determine the amount of processing required for a particular video output quality. As an example, the window size determines the embedded resizing techniques that can be applied without loss of visual output quality, see Z. Zhong and Y. Chen, Scaling in MPEG-2 Decoding Loop with Mixed Processing, Digest of Technical Papers IEEE International Conference on Consumer Electronics (ICCE), pp. 76-77, June 2001.

Hence, alternative parameters have to be used for high-quality video. These parameters-are typically video algorithm specific and may vary per algorithm. Optional parameters for high-quality video are number of filter coefficients (e.g. 0, 8, 32, . . . ), number of fields used (e.g. 1, 2, 3, . . . ), reference objects (e.g., points, lines, . . . ), and type of processing (e.g. linear, non-linear).

Consumer products are heavily resource constrained, with a high pressure on silicon cost and power consumption. In order to be able to compete with dedicated hardware solutions, the available resources will have to be used very cost-effectively, while preserving typical qualities of HVE CTs, such as robustness, and meeting stringent timing requirements imposed by high-quality digital audio and video processing.

In HVE CMTs, software media processing is done using dedicated media processors, such as TriMedia™ Technologies Inc.'s family of very long instruction word (VLIW) processors, see F. Sijstermans and G. Slavenburg, Providing the processing power for consumer multimedia, Digest of Technical Papers IEEE International Conference on Consumer Electronics (ICCE), pp. 156-157, 1997. Compared to dedicated hardware solutions, these media processors are expensive, both in cost and power consumption. Therefore, cost-effectiveness is a major issue in HVE CMTs. Cost-effectiveness requires a high average resource utilisation.

Current HVE CTs provide robust behaviour, and users expect the same robustness when media processing is performed in software and these terminals become more open. For the time being, users do not have similar expectations of multimedia applications on desktops and Internet appliances (and it is also not uncommon that these applications exhibit non-robust behaviour). Note that the notion of resource budgets (or reservations, like in C. W. Mercer, S. Savage, H. Tokuda, Processor Capability Reserves: Operating System Support for Multimedia Applications, In: Proc. International Conference on Multimedia Computing and Systems (ICMCS), pp. 90-99, May 1994) is a proven concept to provide robustness between applications.

High-quality video has a field rate of 50-120 Hz, no tolerance for jitter, and low tolerance for frame skips, properties that are characteristic of the hard real-time domain. In contrast, mainstream multimedia applications are characterised by low frame rates (with a maximum of 30 Hz) and high jitter tolerance, and in addition accept frequent frame skips, properties that are characteristic of the soft real-time domain. It is conceivable, however, that future users will expect guaranteed timing behaviour from multimedia applications on desktops and Internet appliances as well.

In the high-quality video domain, the load of a system varies dynamically on multiple time scales. User initiated changes, such as the exchange of the contents of a main window and a PiP window and switching to another channel, take place at a time-scale of minutes (typically with bursts of occurrences). Similarly, changes initiated by the service provider, such as the interruption of a movie by a commercial, take place at a time scale of minutes. Data dependent changes in the average load of applications take place at a time scale of seconds, e.g. scene changes in a movie. Finally, many media processing functions, such as MPEG encoding and decoding, and motion estimation, have a load that show large data dependent variations over time. These data dependent load variations take place at a time scale of tens of milliseconds. In summary, there are variations around a quasi-fixed average load, and variations that involve a change in the average load.

In order to address dynamic behaviour at different time scales, a multi-level adaptive control structure has been conceived, see S. van Loo, L. Steffens, R. Derwig, Quality of service Resource Management in Consumer Terminals, Philips Research Laboratories Eindhoven (PRLE), Doc. id. NL-MS 21166, available from http://www.research. philips.com/manuscript/index.html, May 2001, corresponding with different time-horizons as in Z. Uykan, Hierarchical control and multimedia, Multimedia applications in industrial automation—Collected papers of the Spring 1997 postgraduate seminar, (Eds. H. Hyötyniemi and H. Koiva), Helsinki University of Technology, Report 106, pp. 91-114, ISBN 951-22-3835, June 1997.

Multi-level adaptive control is realised by means of a co-operative approach between media applications and QoS resource management. This control is founded on a layer providing the functionality of a resource kernel, guaranteeing and enforcing resource budgets and supporting an admission test.

A resource kernel provides robustness between applications, resolving the temporal interference between applications, which is in particular a major threat for open systems. The issue of cost-effectiveness of HVE CMTs gives rise to an additional robustness problem within applications. Cost-effective media processing requires a high average resource utilisation. This requirement is in conflict with the hard real-time requirements of high-quality video that are traditionally met by a worst-case resource allocation. Since the traditional real-time approach is not affordable for CMTs, it is wise to opt for a more average-case resource allocation. Given the dynamic load, applications will therefore be faced with occasional (or transient) and structural overloads. The resulting robustness problems are to be resolved by the applications themselves. Stated in other words, applications have to get by with their budget.

The lowest layer of adaptive control, on a time scale of tens of milliseconds, therefore reside within the media applications. By using an MPEG-2 decoding complexity estimation model, the required computational load can be predicted, and the computation is subsequently scaled such that it will not exceed its resource budget. A similar example may be found in G. Lafruit, L. Nachtergale, K. Denolf, and J. Bormans, 3D Computational Graceful Degradation, Proc. IEEE International Symposium on Circuits and Systems (ISCAS), Vol. 3, pp. 547-550, May 2000, describing adaptive control for 3D decoding and rendering.

Subsequent layers of adaptive control are a Resource Manager (RM) and a QoS resource Manager (QM). The RM works on a time-scale up to hundreds of milliseconds, and provides a control layer between scalable algorithms (SAs) and the platform and operating system, and the QM. The RM monitors the resource usage of applications, and based on these measurements adapts the budgets to their optimal values, and informs QM about these adaptations. Occasionally, RM is not able to accommodate the resource needs of the applications, and requests assistance from QM. The highest layer of adaptive control resides in the QM, which works on time-scales longer than hundreds of milliseconds.

In the pending application WO 0219095, adaptive control is situated on three layers. Besides a local Resource Manager and a QM, a socalled Strategy Manager (SM) is described. This SM is controlling the overall scaling of quality levels of different applications. The SM satisfies a need for communication between the QM and scalable applications which use scalable algorithms (SAs) such as a scalable MPEG2 decoder.

FIG. 1 schematically shows an example of an SA 1. The SA 1 basically consists of an algorithm for media processing 2 and a quality control block 3. The SA 1 can be split in a number of specific functions 4, 5, 6, 7 some of which are scalable. The quality of the output depends on the appropriate combination of the quality levels of these functions. From these combinations, only a few provide acceptable quality levels for the SA 1. The optimal quality-resource combinations are connected by a curve with maximum quality at lowest resources. The quality control block 3 contains this information and the appropriate settings for the functions. This concept imposes many responsibilities to the SM. The SM has to deal with every single algorithm, the configuration of SAs for different applications, the application specific optimisation etc. In addition, the SM has to adapt the SAs to all kinds of changes, requested by the user or the system (QM). Furthermore, the input and output parameters have to be taken into account, which might be difficult for parts of the processing chain. All these responsibilities within one SM module makes it difficult to design, maintain, and adapt the SM to new functions or applications.

It is an object of the invention to provide a method for running a media application that results in an improved system optimisation and resource allocation.

### SUMMARY OF THE INVENTION

Therefore the present invention relates to a method of running a media application, the media application comprising a number of algorithms, each algorithm being either scalable or non-scalable, the method comprising:

(a) receiving an input signal,

(b) executing said algorithms to generate an output signal,

(c) defining a job as being a set of possible clusters of algorithms, for performing a certain predefined part in a processing path,

(d) selecting a job mode for each job in the media application on the basis of input and/or output specifications, a job mode being one specific cluster of algorithms out of the set of possible clusters.

By clustering algorithms executing a specific task, a job control unit can control the quality and resource management for one job, and thereby relieving a strategy manager.

Preferably the method mentioned above, comprises the selecting of an operational state of the job, whenever a system change occurs, the selection being dependent on:

the job mode,

a set of valid quality levels of the job mode, which is called operational set,

an assigned output quality level.

By dynamically selecting the appropriate job state, each job will be optimised in terms of resource utilisation and output quality. This will result in an improved optimisation of the total system resources.

Furthermore the invention relates to a media system, comprising input means for receiving an input signal, and a processor, the media system being arranged for running a media application, the media application comprising a number of algorithms, each algorithm being either scalable or non-scalable, the processor being arranged for:

(a) executing said algorithms to generate an output signal,

(b) selecting a job mode for each job in the media application on the basis of input and/or output specifications, a job mode being one specific cluster of algorithms out of the set of possible clusters of algorithms, which set is called a job,

(c) selecting an operational state of said job whenever a system change occurs.

In an embodiment the media system is a multimedia communication device, such as a digital consumer multimedia terminal.

Finally the invention relates to a computer program product arranged to perform the method described above, and a storage medium comprising such a computer program product.

### BRIEF DESCRIPTION OF THE DRAWINGS

Below, the invention will be explained with reference to some drawings, which are intended for illustration purposes only and not to limit the scope of protection as defined in the accompanying claims.

FIG. 1 shows an example of a Scalable Algorithm from the state of the art.

FIG. 2 schematically shows an example of a job.

FIG. 3 shows some job modes of a video enhancement job.

FIG. 4 is a graph of discrete quality levels as a function of resources for a job at a specific job mode.

FIG. 5 is a scheme of the quality/resource control units.

FIG. 6 shows a mapping between some job modes and the corresponding quality levels.

FIG. 7 schematically shows an example of a job mode change.

FIG. 8 schematically shows an example of a media system according to the invention.

### DESCRIPTION OF PREFERRED EMBODIMENTS

A common CMT may accept input from different types of input sources, such as satellite, cable, storage device, Internet and Ethernet. The video input can be digital or analog. A CMT may have a number of video outputs: a display, a storage device (such as VR, DVD+RW, or a hard disk), and an IEEE 1394 or Internet link. The outputs on a display may be sub-divided into two (dynamically changing) groups based on user-focus. User focus induces a relative importance on outputs. Between these inputs and outputs, a number of processing paths may exist, containing joins and forks in complex situations.

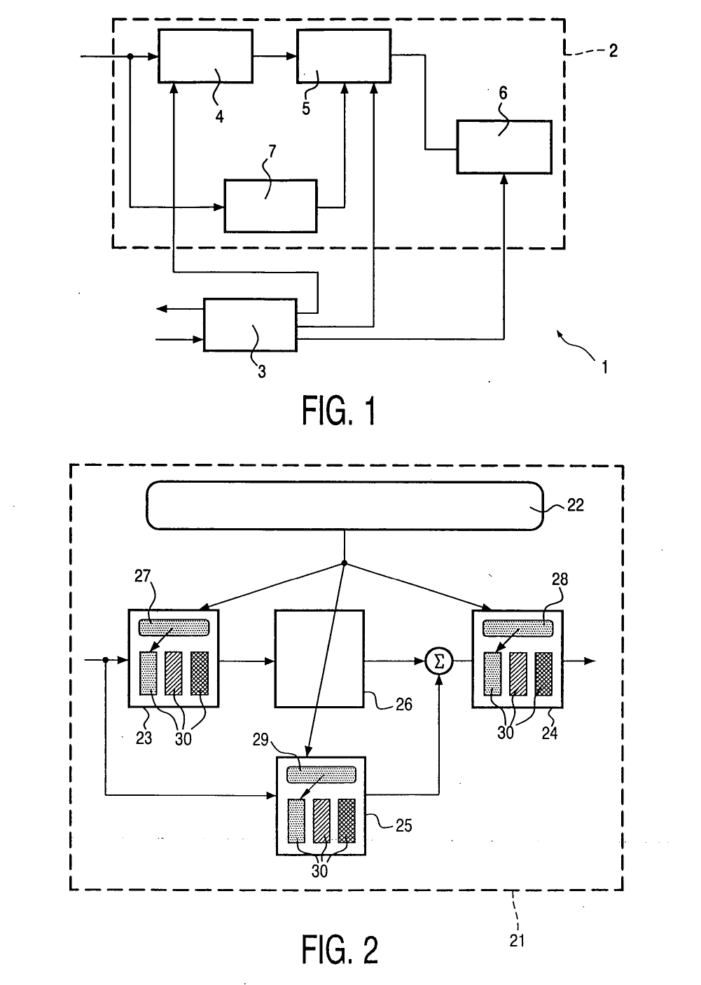

Each processing path within a CMT typically consists of a number of functional processing parts, e.g. channel decoding, picture enhancement, and rendering (for a display) or encoding (for a link). Each part consists of a certain combination (cluster) of tasks that are necessary to perform the specific job. Therefore in this invention these functional processing parts are called jobs. If a CMT is a scalable programmable media device, it will contain a number of scalable algorithms (SAs). In this case a job will consist of a cluster of SAs (and possibly non-scalable algorithms (NSAs) too). FIG. 2 schematically shows an example of job 21. The job 21 comprises a resource control unit 22, several SAs 23, 24, 25 and a non-scalable algorithm 26. The resource control unit 22 communicates with the SAs 23, 24, 25. Each SA 23, 24, 25 comprises a Quality Control (QC) 27, 28, 29 which controls the resources for functions 30. The structure of the SAs resembles the state of the art structure shown in FIG. 1.

Whereas the functional description of a job is general (e.g. enhancement or a combination of tasks for decoding and enhancement or others), there may be a number of specific tasks (processing variants) within a single job that are specific and dependant on certain parameters, such as the channel, the source, the format and the output mean. For example, scan-rate conversion is dependent on the display type (e.g. interlaced or progressive), and the type of the input data (interlaced or progressive), respectively. This results in different sets of functions (type of processing) for different parameters, within the same job. The parameters may change dynamically, for example, due to a channel change, or the exchange between windows. Certain settings of these parameters define unique combinations of functions for the job, that we call job modes.

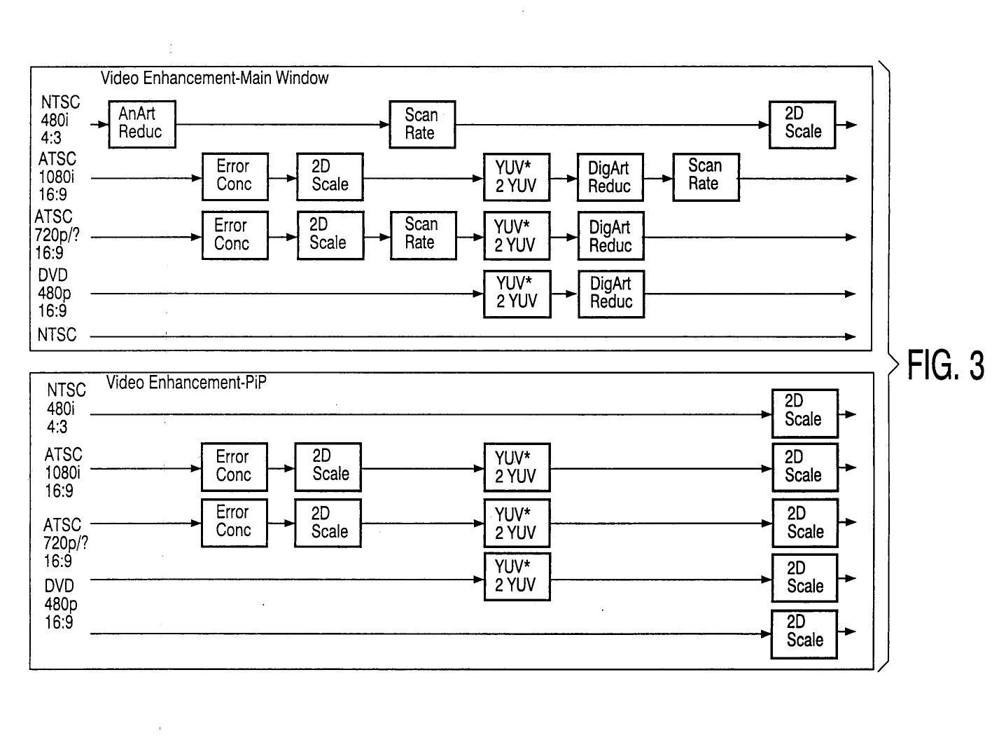

In FIG. 3 some examples of job modes of a video enhancement job for different sources, formats, and output windows are given. From this figure one may see that the functionality, the number, and order of tasks in the video enhancement job is different for different sources, formats, and display windows. This results in different job modes.

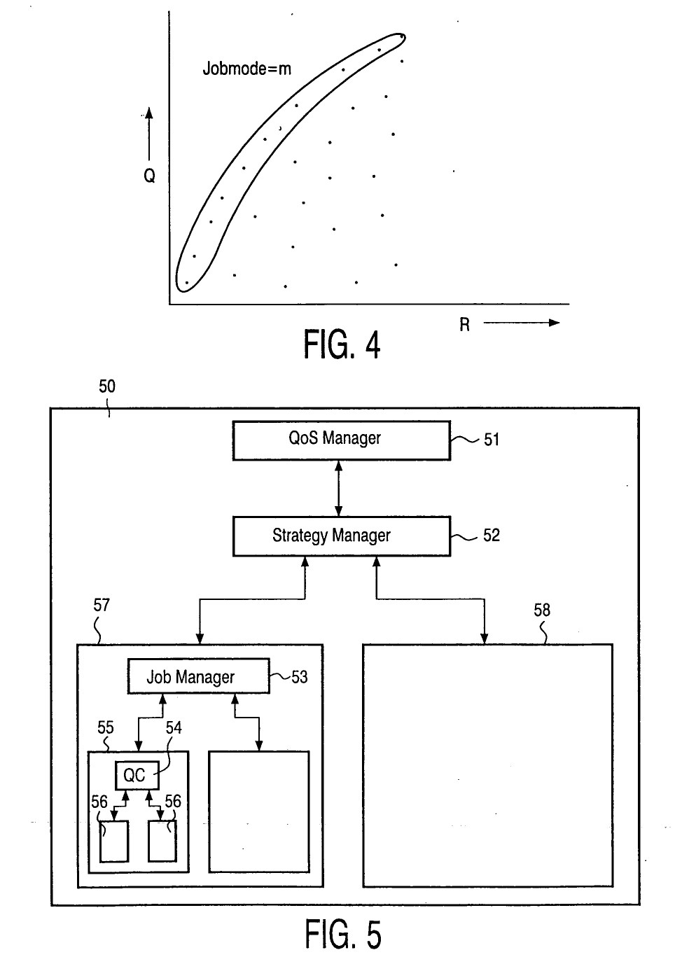

Similar to SAs, jobs can be scaled, giving rise to a set of discrete quality levels associated with each job mode. Jobs provide (estimated) resource requirements for each quality level. In FIG. 4 an example of a set of discrete quality levels is shown. In FIG. 4 the output quality level of a job at a certain job mode m is drawn against the amount of resources. Each dot in the ‘cloud’ represents a quality level resulting from a certain amount of resources used by the different SAs that make up the job. Given an amount of resources, different distributions of this amount among the SAs may be possible. Some divisions result in a higher quality level than others. This fact can be seen in the graph of FIG. 4, i.e. two or more-dots around a vertical line.

In the case of jobs being clusters of SAs, one may expect that the range of visual output quality of a job (i.e. the size of the ‘cloud’) is dependent on the type of the input source data and the type and size of the output means (window/speaker, storage device). For example, if the video source data are High Definition (HD) and are displayed in a HDTV, then the output quality will be much higher than if the source data are Standard Definition (SD). Thus the set of quality levels for each job and thus for each processing path depends on the specific job mode m.

Therefore, in a scalable programmable processing device according to the invention, before selecting the possible quality levels (set of resources and thus the corresponding output quality) of a job, the specific job mode m in which the job is active is selected. This selection is done dynamically, i.e. whenever a system change occurs, a selection of a (possibly different) job mode is done.

A change of job mode, e.g. due to a channel change or an exchange of the contents of the main window and a PiP window, is termed a job mode change (JMC). A JMC may lead to a change in the specific functionality of the job, and the number and order of its algorithms. For each job mode, a number of operational sets are defined, which will be described in the following. In FIG. 4 the quality levels at the top of the ‘cloud’ make up the operational set. Each operational set determines specific processing for each algorithm depending on characteristics like window-size (determining the applicable embedded resizing techniques) and user-focus. An operational set is selected dynamically, and a change of operational set is termed operational-set change (OSC).

FIG. 5 schematically shows an example of the functional structure of a media system 50 according to the invention. In the system 50 different jobs are executed at the same time. The resources for these jobs are controlled by a QoS Manager (QM) 51. The QM 51 is responsible for the robustness, efficient resource use and optimisation of the system 50. Such task can be accomplished through an effective interface between the different applications and the QM 51. According to the invention, the interface is seperated in three levels, namely a Strategy Manager 52, a Job Manager (JM) 53 and a Quality Control (QC) 54. The QC 54 is a control unit controlling an SA 55. An SA 55 performs specific functions 56, for example noise reduction. It also provides different ways to perform the same function with different resource requirements, and thus different output qualities. Each of these ways define a scalability level l∈L, L→{(Rₗ, Qₗ)}, where (Rₗ, Qₗ) denotes the resources required, and the output quality attained for the level l, see the pending application WO 0219095. The scalability levels l of the SA 55 are defined by the algorithm designer, and are set by a predefined set of the algorithm specific parameters (e.g. number of coefficients). The QC 54 sets the necessary parameters, in order to implement the scalability level l requested by the QoS system.

At initialization, the JM 53 provides the higher layer (i.e. the SM 52) with a set of scalability parameters P, the job modes Mand, for every job mode m∈M, the valid quality levels {(Rₘ, Qₘ)}, where Rₘ denotes the resources required for the job, and Qₘ denotes the common output quality attained for parameter p at job mode m. At run time, it sets the scalability levels of the SAs of the current job mode, as requested from higher layers (SM 52 and QM 51). The QM 51 performs a resource utility optimization of the system which may serve a number of different applications, such as video, audio, graphics, internet, storage and other. In order for the optimization to be performed in a fast and fair way, preferably all specific application semantics are stripped from the application. In the embodiment, the SM 52 is the interface between the QM 51 and the media applications. That is, each media application may have its own SM 52. One task of the SM 52 is to translate information with media semantics to the space without media semantics of the QM 51. Quality dimensions for scalable algorithms are algorithm, source data and output means specific. Preferably, the QoS system is blind to them because of three reasons:

to avoid plethora of unnecessary information,

to support portability to different platforms (change with system),

to support update (change with time).

The SM 52 selects the job modes of the jobs during job mode changes, and informs the QM 51 of the operational sets of each job mode, in a processing path. In an embodiment the SM 52 takes into account relevant information from other modules of the system, like a Windows Manager (WM), a User Interface (UI) and SMs from other media applications.

Thus, the SM 52 selectively minimizes the quality search space for the QM 51 to include only the effective quality points. In an embodiment, the information that it passes to the QM 51, besides the operational set for each job, is a number of weights that define the importance of the jobs, and depends on the output window size. These weights are then further utilized by the QM 51 during a system optimization stage.

In order to allow system optimization by the QM 51, the quality/resource values of a job are expressed, in semantically neutral terms, as a job utility.

Preferably, the QM 51 selects those quality levels at which the jobs are executed in such a way, that an-overall system utility is maximised, and the resource requirements meet the resource availability. The overall system utility is determined by the job utilities of the running jobs, the dependencies (resulting from the processing paths) of the running jobs, and the relative importance levels that are associated with those jobs.

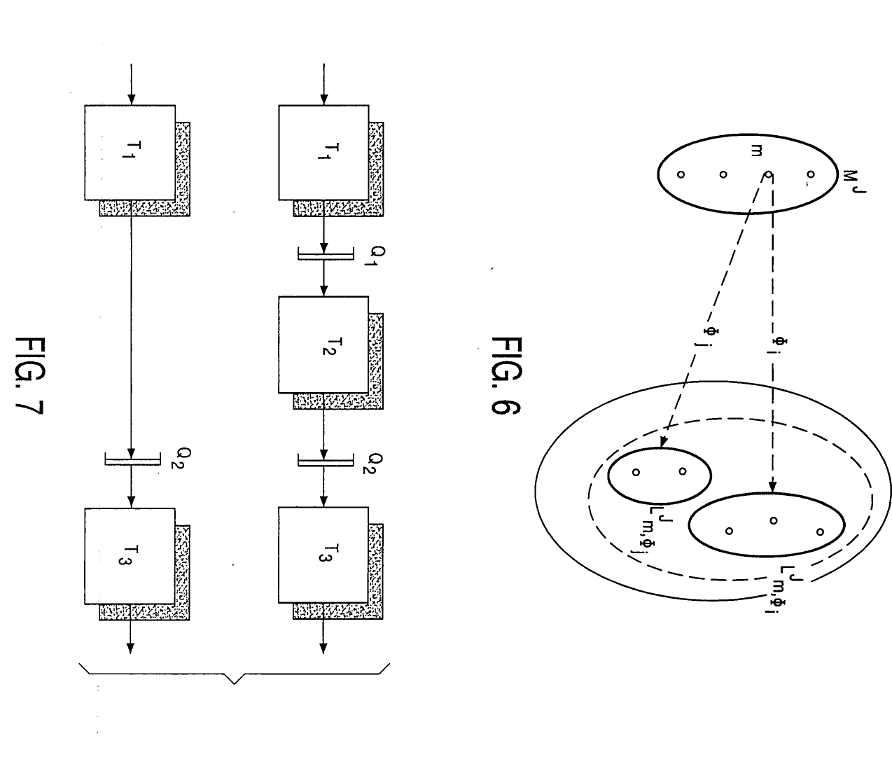

Next to performing the global (centralised) optimisation of the system utility, the QM 51 maintains socalled quality mappings (see FIG. 6) from the running jobs (based on the dynamic resource needs provided by the QC 54). Changes in the number of jobs, relative importance of the jobs, quality mappings of the jobs (due to JMCs and OSCs), and requests for assistance from the QC 54 require re-optimisations. Because rapidly changing quality levels are perceived as non-quality, quality levels must be adjusted sparingly. Note that this aspect is not covered in C. Lee, J. Lehoczky, R. Rajkumar and D. Siewiorek, A scalable solution to the multi-resource QoS problem, Proc. 20^{th} IEEE Real-Time Systems Symposium (RTSS), pp. 315-326, December 1999, nor is the incorporation of dependencies between jobs for overall quality optimization.

A JMC may lead to a change in the number and order of the algorithms 23, 24, 25 of a specific job. At a JMC the switching must be seamless, and that intermixing of old and new-mode data upon reconfigurations of the connections of algorithms must be prevented.

In an embodiment, the media applications are responsible for providing seamless switching and preventing data intermixing. The QM 51 must ensure that the applications get the necessary resources to do so (i.e. get a guaranteed resource budget), as illustrated by the following example.

In a media system a switch to another channel may involve JMCs, requiring a re-optimisation by the QM 51, giving rise to new quality levels of running jobs. In such a case, quality level reductions of jobs are performed first, followed by resource budget reductions of those jobs. As a next step, resource budgets of jobs that will receive a higher quality level are increased, followed by the increase of the quality level.

### Types of Changes

Considering a Multimedia TV system, a number of changes of its steady state may come to mind; changing a channel, open a new window to watch a different application, exchange windows, and other. All these cases introduce a number of changes in the system and in the jobs of each path. Below, three types of changes are described that are performed in (clusters of) scalable video algorithms (SVAs), the job mode changes, the operational set changes, and the quality level changes. The changes,-and their cause are summarized in Table 1, and are explained in the following.

### Job-mode Changes

In a job mode change (JMC) the basic set of functions of the job changes. This set of functions is necessary to provide the correct output. JMC are characterized by possible big changes in the resource requirements and clear changes in visual quality. They are activated by the user, or a change in the source characteristics of a channel, but never from the QoS system. For better understanding of the nature of job mode changes, some examples are given below.

Exchange between Main and PiP window. The processing of the same source may be different for the Main and for the PiP (Picture-in-Picture) window. Thus, when the user exchanges the two windows, Job-mode changes to both paths are performed. This corresponds to case 1 in Table 1. Such a change is requested via the User Interface (UI).

Channel Change. The user changes a channel with the source of the new channel (e.g. digital) being different from the old (e.g. analog). This example corresponds to case 2 in Table 1. A channel change is requested via the UI.

In-channel source change. The service provider within the same channel may transmit sources with some input parameters different, for example a movie (film) interrupted by a commercial (video). Such a change is detected by the processing of the data (e.g. video decoding), and is used to initiate job mode changes in the appropriate jobs of the path (case 3 in Table 1).

Any JMC induces an operational set and, thus, a quality level change for this job, and possibly quality level changes (QLCs) to the other active jobs in the system.

### Operational Set Changes

In operational set changes (OSCs) the basic set of functions of a job does not change (same job mode). The set of required resources changes, that is, the operational set. OSC are characterized by different resource requirements within a job mode and expected changes in visual quality. They are activated by the user.

Some examples of operational set changes follow.

Change of focus. When a number of applications (windows) are on, the available resources may not be enough to support highest output quality for all of them. The user may specify which of the windows is more interesting for him (has his focus) letting the QM 51 to adjust the quality levels of the other windows in a lower range. The set of valid quality levels (i.e. the operational set) is different for applications with focus and applications without focus. The user may decide to alter the focus of one or more windows (case 4 in Table 1). This action may lead to a change of the operational set for each of these windows.

Change of window size. The set of resources requested by a job mode for a set of output quality levels may be dependent on the size of the display window (i.e. puncturing and embedded resizing techniques). Hence, a change of display window size may be accommodated by a change in operational set (case 5 in table 1).

Any OSC induces a quality level change (QLC) to this job and possibly to the rest of the jobs in the system.

### Quality Level Changes

In quality level changes (QLCs) the basic set of functions of a job (ob mode) and the operational set remain the same. A quality level of the set of valid quality levels of the job mode changes, that is, its resource requirements, and its output quality. QLC are characterized by different resource requirements within an operational set of a job mode and changes in visual quality. They are activated by the QM 51, SM 52, or the user. As we have already presented above, any JMC or OSC of a job leads to a QLC to this job and possibly to the rest of the jobs. Some other examples of causes for quality level changes are the following.

Start new application. The user may decide to open a new window to watch a new application (e.g. new program). The new application creates new jobs, and this may lead to an indirect effect to the already existing jobs. The new jobs may require an extra amount of system resources that are not available. In this case the existing jobs should free some resources, which can be accomplished by lowering their quality level (case 6 in table 1). A reverse effect can be featured when an application is switched off.

Load change. There are video algorithms whose load is sensitive to certain parameters of the video content, such as motion and details. If the load of an algorithm, and thus of a job, is higher than initially claimed, then the QM 51 may react by allocating more resources to the job. If there are not enough available resources the QM 51 or SM 52 may reduce the quality level of this (or some other less important) job (case 7 in Table 1).

TABLE 1
Types of changes: causes and effects.

| Case | Change | Cause | Effect on Job |
|---|---|---|---|
| 1 | User | Window | Job-mode |
| 2 | | Source | change |
| 3 | Provider | | |
| 4 | User | Focus | Operational set |
| 5 | | Window size | change |
| 6 | User | # of Apps | Quality level |
| 7 | Video contents | Load | change |

Before the description of the dynamic behavior of the system is described, first the parameters that describe the steady state of a job are defined.

In the media system, a number of jobs J, J=1, . . . , |B|, are running. Each job J has a set of job modes M^{J}. Each job mode m∈M^{J} has a set of tasks (i.e. SAs) N^{J}ₘ and a set of operational mappings Φ^{j}ₘ. The range of each operational mapping φ∈Φ^{J}ₘ is a set of valid quality levels L^{J}_{mΦ}, (i.e., an operational set). A graphical representation of the relations between job modes, operational sets and mappings, and quality levels is provided in figure. 6. The dots in the M^{J} oval represent job modes. The dots in the L^{J}ₘΦ ovals represent quality levels l, similar to the dots shown in FIG. 4.

Each quality level l∈L^{J}_{m,Φ}maps to a tuple (R,Q)ₗ, that defines the resource requirements and the respective visual output quality that the job supports.

The resource requirements R is defined by R=(r₁, r₂, . . . , r_{|R|}), where r_{i,} i=1, . . . ,|R| is the (static) amount requested from resource type R_{i, and |R| is the number of system resources. These resource requirements R are used in an admission control and in the budget (re)allocation procedures.}

The output quality values Q are provided for the system optimization. One of the main issues of this invention is that the output visual quality (being correct and optimal) is a major factor of the system performance. However, in order to perform optimization in a semantical neutral way the output quality values Q are translated to job utilities u, with uₘᵢₙ<u<uₘₐₓ, with uₘᵢₙ and uₘₐₓ being the lowest and highest, semantically neutral quality levels. On a regular base, the set of tuples {(R,u)ₗ}_{l∈L}_{^{J}}_{m,φ} that corresponds to the appropriate mapping φ, is provided to the QM 51 by the SM 52 to perform the system optimization.

So the job state S^{J} is described by:

the current job mode,

the appropriate operational mapping, and

the assigned quality level, i.e., S^{J}=(m^{J}, Φ^{J}ₘ, l^{J}_{m,Φ}).

The jobs 57, 58 are responsible for selecting the appropriate job mode and operational mapping and for providing the corresponding operational set to the QM 51, at each JMC and OSC. The QM 51 is responsible for selecting the quality level of each job in the system. Changes of job states have implications for the system, as well as for the functionality and the control of the video processing modules. The later implications are described below.

Each job mode m∈M^{J} consists of a specific combination N^{J}ₘ of tasks. The synchronization between tasks is performed through local queues. A task receives data from its input queue, processes them and sends them to its output queue(s). The data are sent by means of packets, such as fields, frames, or pointers to fields/frames in the case of shared memory. If the input queue of a task is empty then the task remains blocked until new data arrive at its input queue. A task may also be blocked if its output queue is full.

In a JMC, say from mᵢ to mⱼ, with mᵢ, mⱼ∈M^{J}, the combination of the job tasks is altered. This alteration can be driven by removing some tasks (old), and/or including new ones (new), and/or changing the order or the parameters of some existing tasks (changed). The removal of tasks is accomplished by blocking the tasks that are not included in the new job mode mⱼ. The blocking is attained by not sending data to their input queues. The inserting of tasks is achieved similarly by unblocking them. The order of the tasks is defined by the job mode mⱼ, and is controlled by the control part of the tasks (SVAs) through the setting of their output queues. In FIG. 7, an example of a JMC is shown.

One of the main issues in a JMC is that any alteration in the set of tasks should be performed seamlessly. In the video processing chain it is important that the process of each task is applied to the correct data. If the JMC is synchronized with the new data we prevent wrong output image format. For example, let's assume that the old source was a HD source, and the display is SD. Then the old job mode reduces the resolution of the input source to match the display requirements. Let's, also, assume that the new source is SD and the processing does not adapt in time. Then, until the correct processing is set the output resolution would be a reduced resolution of an SD source on an SD display! In an embodiment of the invention, effective transitions are attained by mode stamping the data, and having the control part of the SAs (i.e. the QC 54) being job mode aware.

In a JMC, the set of tasks changes, but also the connections between the tasks. Therefore, another important issue is the prevention of intermixing old and new-mode data. Data can be inter-mixed when, for example, a task T1 is rerouting its new-mode output data to T3 in order to block T2, while T2 has not finish execution on old-mode data, see FIG. 7. If this happens, then first new-mode data arrive in the input queue of T3 (Q2), followed by old-mode data. Data intermixing can be prevented by manipulating the priorities of the tasks during a job mode change (having T2 higher priority will assure that it will finish processing before T1 reroutes). Another solution can be provided by controlling the timing of rerouting of the output queues of the tasks. For example, task T2 sends a permission signal to T1 when it has finished the old-mode data, and T1 waits for this permission signal before sending the new-mode data to Q2 . A third solution supports data order restoration. The input queue of T3 (Q2) consists of two sub-queues which are mode specific. Thus, the queue controls the correct separation (routing) of old and new-mode data in the respective sub-queues, and only when the old-mode data are finished then new-mode data are sent to the next task (T3).

The first solution implies changing the priorities of tasks at run-time which increases the system overhead. The third solution is a very attractive one but requires a system that supports such queue management. Although the second solution complicates the design of the control part of the SAs, it turns out to be very efficient. It is the one we prefer.

As was described above, in an OSC or QLC the set of tasks of a job does not change; the job mode is maintained. In an OSC, the mapping is changed from φₗ to φⱼ, see FIG. 6. This is the outcome of the change in resource needs, defined by the processing that the SA designer introduced to deal with special cases, such as change of focus, or window size.

In a QLC the quality level describing the behavior of the job is modified, say from lᵢ to lⱼ, within the range of the predefined operational mapping, i.e., lᵢ, lⱼ∈L^{J}_{m,φ} (FIG. 6). The QM 51 changes the resources available to the job due to reasons like the ones described above. The job responses to this change by altering the processing of the tasks of the set N^{J}ₘ. By doing so, it secures that the tuple (R,Q)ₗ_{ⱼ} is satisfied.

The quality-levels of-a job-mode are defined by the application designer. The altering of the processing of the tasks (SAs) can be performed by changing the number of coefficients, or fields, or objects considered (e.g. points versus lines) and many more.

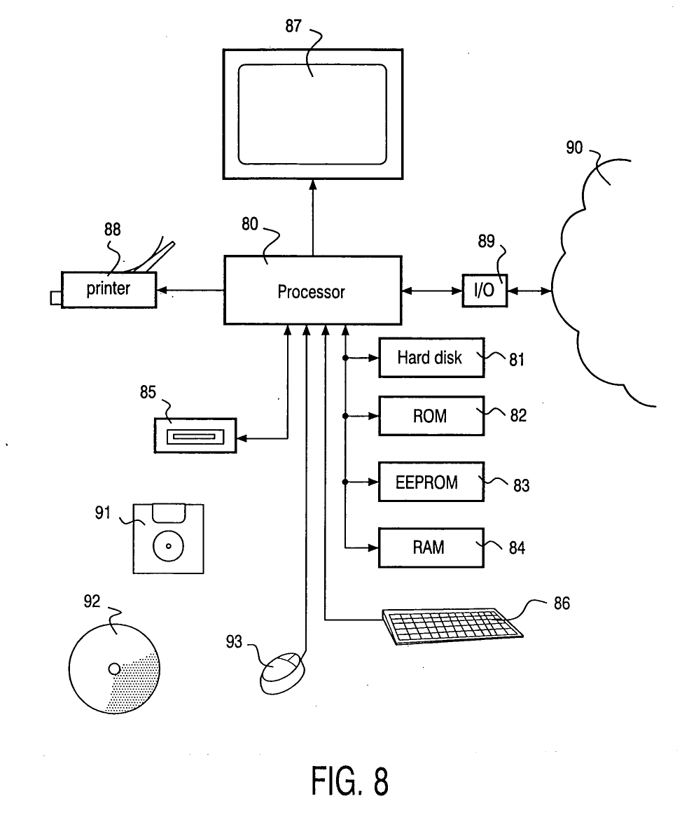

FIG. 8 schematically shows an example of a media system according to the invention. The media system comprises processing means 80 which are connected to memory units 81, 82, 83, 84 which store instructions and data, one or more reading units 85 (to read, e.g., floppy disks 91, CD ROM's 92, DVD's, etc.), a keyboard 86 and a mouse 93 as input devices, and as output devices, a monitor 87 and a printer 88. Other input devices, like a trackball and a touch screen, and output devices may be provided for. For data-communication over a network 90, interface means 89 are provided for.

The memory units shown comprise RAM 84, (E)EPROM 83, ROM 82 and hard disk 81. However, it should be understood that there may be provided more and/or other memory units known to persons skilled in the art. Moreover, one or more of them may be physically located remote from the processing means 80, if required. The processing means 80 are shown as one box, however, they may comprise several processing units functioning in parallel or controlled by one main processor, that may be located remote from one another, as is known to persons skilled in the art.

While the invention has been described in connection with preferred embodiments, it will be understood that modifications thereof within the principles outlined above will be evident to those skilled in the art. The invention is not limited to the preferred embodiments but is intended to encompass such modifications.

1. A method of running a media application, the media application comprising a number of algorithms, each algorithm being either scalable or non-scalable, the method comprising:
(a) receiving an input signal,
(b) executing said algorithms to generate an output signal,
(c) defining a job as being a set of possible clusters of algorithms, for performing a certain predefined part in a processing path,
(d) selecting a job mode for each job in the media application on the basis of input and/or output specifications, a job mode being one specific cluster of algorithms out of the set of possible clusters.

2. A method according to claim 1, wherein the method comprises:
(e) selecting an operational state of said job, whenever a system change occurs, the selection being dependent on:
the job mode,
a set of valid quality levels of the job mode, which is called operational set.

3. A method according to claim 2, wherein the selection of said operational state of said job is dependent on an assigned output quality level.

4. A method according to claim 1, wherein said input specifications comprise the type of input signal.

5. A method according to claim 1, wherein said output specifications comprise the type of output format.

6. A method according to claim 1, wherein the method comprises:
(f) expressing a job output quality value in semantically neutral terms, as a job utility,
(g) determining an overall system utility from the job utilities of all the jobs.

7. A method according to claim 1, wherein the method comprises:
(h) passing only the operational set to a Quality of Service Resource Manager for each job,
(i) passing a number of weights that define an importance of the jobs to the Quality of Service Resource Manager,
(j) optimizing a media system using the number of weights and the operational sets of the different jobs in the Quality of Service Resource Manager.

8. A method according to any claim 1, wherein a change of job mode is synchronized with new data to prevent a wrong output image format, and wherein effective transitions are attained by mode stamping the data.

9. A method according to claim 1, wherein, in order to prevent intermixing of old and new-mode data present in output queues of the algorithms, the priorities of the tasks are manipulated during a job mode change.

10. A method according to claim 1, wherein, in order to prevent intermixing of old and new-mode data present in output queues of the algorithms the timing of rerouting of the output queues of the tasks is controlled.

11. A media system, comprising input means for receiving an input signal, and a processor, the media system being arranged for running a media application, the media application comprising a number of algorithms, each algorithm being either scalable or non-scalable, the processor being arranged for:
(a) executing said algorithms to generate an output signal,
(b) selecting a job mode for each job in the media application on the basis of input and/or output specifications, a job mode being one specific cluster of algorithms out of the set of possible clusters of algorithms, which set is called a job,
(c) selecting an operational state of said job whenever a system change occurs.

12. A media system according to claim 11, wherein said processor is arranged to process:
at least one application operable in a plurality of application modes;
a Quality of Service Resource Manager for determining whether said available resources are suitable for operation of at least one media algorithm needed to execute said at least one application in a given one of said application modes; and for tracking how much computing resources are available for use by said at least one application;
a Strategy Manager for selection and configuring the media algorithms to clusters of media algorithms (Jobs)
at least one local Quality Control for controlling settings to be used by said at least one media algorithm,
at least one job control unit for controlling resources/quality for said cluster of media algorithms, said job control unit being responsive to said Strategy Manager and to local Quality Control selecting the resources of the media algorithms in said cluster.

13. A media system according to claim 12, wherein said job control unit is arranged to receive a required job quality level from said Strategy Manager, and to translate the required job quality level into quality levels l for each of said at least one algorithm present in said corresponding cluster.

14. A media system according to claim 13, wherein said job control unit provides said Strategy Manager with a set of scalability parameters P, the job modes M and, for every job mode m ∈M, an operational set {(Rm ,Qm)}.

15. A media system according to claim 14, wherein at run time, said job control unit sets the scalability levels of the scalable algorithms of the current job mode, as requested from said Strategy Manager or from said Quality of Service Resource Manager.

16. A media system according to claim 11, wherein the media system is a multimedia communication device.

17. A computer program product arranged to perform the method according to claim 1.

18. A storage medium comprising a computer program product according to claim 17.
